(19) United States
(12) Patent Application Publication
(10) Pub. No.: US 2011/0215645 A1
(43) Pub. Date: Sep. 8, 2011

(54) CONTAINERIZED CONTINUOUS POWER SYSTEM AND METHOD

(75) Inventors: Markus Schomburg, Osterode (DE); Uwe Schrader-Hausmann, Osterode (DE); James Murphy, Worcestershire (GB); Ron Landis, Austin, TX (US); Karl Schuetze, Austin, TX (US); Bradley Walter, Lockhart, TX (US)

(73) Assignee: ACTIVE POWER, INC., Austin, TX (US)

(21) Appl. No.: 12/940,858

(22) Filed: Nov. 5, 2010

Related U.S. Application Data
(60) Provisional application No. 61/310,775, filed on Mar. 5, 2010.

(51) Int. Cl. H02J 9/08

(52) U.S. Cl. 307/65

(57) ABSTRACT

It is an object of this disclosure to provide an efficient continuous power system that may be deployed quickly and at low cost to a variety of destinations. The containerized nature of the presently disclosed system may allow these advantages to be attained. The disclosed system is particularly well suited for deployment in data center applications, but one of ordinary skill will recognize that it may be useful in a variety of situations.

### CROSS-REFERENCE TO RELATED APPLICATIONS

This application claims priority to U.S. Provisional Patent Application Ser. No. 61/310,775, which is hereby incorporated by reference in its entirety.

### FIELD

The present disclosure relates to power generation systems. More specifically, the present disclosure relates to portable, containerized power generation systems that may be housed in a standard shipping container. The present disclosure may be useful as a backup continuous power system in conjunction with the power grid, or as a primary power generation system at locations not serviced by a power grid.

### DESCRIPTION OF THE RELATED ART

Traditionally, large-scale continuous power systems have required a heavy investment of time and capital to complete as a “brick and mortar” installation. Further, such brick and mortar systems may tend to have a set output capacity that cannot easily be upgraded as needs change. Therefore, in order to be viable for a period of many years, the systems are often built to a specification that far exceeds the initial power requirements. Otherwise, the growing demand at a site might soon outstrip the capacity of a newly installed brick and mortar system. A brick and mortar system built to supply only the amount of power needed at the time of design could even be underpowered by the time it was finished, given the lengthy construction times associated with traditional brick and mortar systems.

Traditionally, batteries are used in conjunction with fuel-based power generation equipment in continuous power systems. When grid power fails, batteries provide short-term backup power during the time it takes for a generator to come online.

This traditional reliance on batteries for short-term continuous power has disadvantages that may be eliminated in accordance with the present disclosure. For example, batteries require a large, dedicated, temperature-controlled space. They also require costly replacement periodically as they wear out. Further, batteries tend to use heavy metals and toxic chemicals, requiring special precautions when they are replaced.

Furthermore, traditional large-scale continuous power systems are generally built from a set of components (such as a generator, a battery-based UPS, switchgear, environmental control systems, etc.) from different manufacturers. A drawback to this approach is that, while such components are generally capable of connecting to a computer for monitoring and control purposes, there is a large variety of physical and logical connectivity options in use by such hardware. And the protocols that these components often use are incompatible with each other. Thus, the components are not in communication with each other, and no centralized monitoring and control solution is available.

### SUMMARY

Therefore, it is an object of this disclosure to provide a continuous power system that may be deployed quickly and at low cost to a variety of destinations. The containerized nature of the presently disclosed system may allow these advantages to be attained. The disclosed system is particularly well suited for deployment in data center applications, but one of ordinary skill will recognize that it may be useful for supplying a critical load in a variety of situations, and the claims should not be construed to be limited to data centers.

The presently disclosed system may include a high-efficiency flywheel-based uninterruptible power supply (UPS) for supplying power for generally under one minute, a standby engine for longer-term power generation, means for starting the standby engine, switchgear, chilling equipment, etc. All or some of these components may be integrated into a standard container for easy deployment. In some embodiments, the chiller may be omitted, and cooling may be provided via the cooling system of the critical load being powered by the system (e.g., chilled water from a data center cooling system).

It is a further object of this disclosure to provide a centralized monitoring and control system. This system may be able to communicate with the various components using disparate protocols, aggregate data, and present a simple, unified interface for the customer.

The presently disclosed system allows for less investment of money, time, and space compared to known continuous power systems. It may further provide a more efficient and “green” solution than previously known methods, as described more fully below.

The present disclosure may eliminate the known disadvantages associated with batteries by using a flywheel for energy storage instead of a chemical battery bank. Battery-based systems may also be more likely to fail and less efficient than the presently disclosed system. The efficiency of the presently disclosed system may reduce the associated carbon emissions and costs, compared to traditional systems.

The present disclosure includes embodiments using batteries for providing cranking energy to a backup generator, but in some embodiments it may totally eliminate the need for batteries. It is known in the art that a large percentage of the failures in continuous power systems are due to battery failures. Thus, in the embodiments of the present disclosure that include batteries for starting the generator, a redundant starting system, based on the energy stored in the flywheel UPS, may also be included for increased reliability.

A further advantage of the presently disclosed system is that much of the effort of deployment may be carried out in the manufacturer's factory, rather than on site at the deployment location. In a traditional brick and mortar setup, engineering, component logistics, assembly, testing, and installation must all be carried out on-site. Using the disclosed systems and methods, all of that work may be completed in the factory, before a customer even orders a system. Delivery of a pre-assembled, pre-tested system reduces the amount of on-site work to just site testing and commissioning, allowing the system to be deployed much more quickly from the customer's standpoint.

As power needs change, the modular nature of the disclosed subject matter may allow a customer to quickly add more capacity without the expense of replacing the existing infrastructure. Containerized systems may be built to a variety of specifications, allowing the customer to begin with as much capacity as is needed, and later add capacity as it becomes necessary.

Further, the containerized system may be deployed in a variety of locations, in accordance with the requirements of the installation site. For example, it could be installed on a roof, in a redundant loading bay, inside a building, in a secure compound, or in a parking area. Once installed, the system may be disconnected and moved to a different site in a matter of hours, if needs so dictate.

In accordance with the present disclosure, an entire continuous power system may be integrated into a single shipping container for a single-container system. Alternatively, for higher-power applications, different components may be contained in a plurality of containers. The containers may then be connected together to provide an integrated multiple-container continuous power system.

These and other advantages of the disclosed subject matter, as well as additional novel features, will be apparent from the description provided herein. The intent of this summary is not to be a comprehensive description of the subject matter, but rather to provide a short overview of some of the subject matter's functionality. Other systems, methods, features and advantages here provided will become apparent to one with ordinary skill in the art upon examination of the following FIGURES and detailed description. It is intended that all such additional systems, methods, features and advantages included within this description, be within the scope of the claims.

### BRIEF DESCRIPTIONS OF THE DRAWINGS

The features, nature, and advantages of the disclosed subject matter may become more apparent from the detailed description set forth below when taken in conjunction with the drawings in which like reference numerals indicate like features and wherein:

FIG. 1 shows a graph illustrating the scalability of continuous power systems known in the prior art;

FIG. 2 shows a graph illustrating the scalability of the system of the present disclosure;

FIG. 3 shows a graph comparing the costs of the present disclosure to the costs of prior art systems;

FIG. 4 shows a graph comparing the carbon footprint of the present disclosure to the carbon footprint of prior art systems;

FIG. 5 shows a top view of an integrated single-container continuous power system;

FIGS. 6A and 6B show, respectively, a side view and an end view of an integrated single-container continuous power system;

FIG. 7 shows an isometric view of a high-capacity integrated multiple-container continuous power system;

FIG. 8 shows a top view of a high-capacity integrated multiple-container continuous power system;

FIG. 9 shows an isometric view of a cooling system according to the present disclosure;

FIG. 10 shows a high-level schematic of the connections in an embodiment of the present disclosure;

FIG. 11 shows a computer system and related peripherals that may be used in connection with the system of the present disclosure;

FIGS. 12-22 show screenshots of an embodiment of a computerized monitoring and control system in accordance with the present disclosure;

FIG. 23 shows a graph of generator speed over time;

FIG. 24 shows a flowchart of the logic of an embodiment of the present disclosure; and

FIGS. 25-28 show high-level schematics of several possible embodiments of the present disclosure.

### DETAILED DESCRIPTION

The following description is not to be taken in a limiting sense, but is made for the purpose of describing the general principles of the present disclosure. The scope of the present disclosure should be determined with reference to the claims. Exemplary embodiments of the present disclosure are illustrated in the drawings, like numbers being used to refer to like and corresponding parts of the various drawings.

This application is related to application Ser. No. 11/606,848 (“'848 Application”), which is hereby incorporated by reference in its entirety. The '848 Application discloses systems and methods for flywheel-based uninterruptible power supplies, which may be incorporated into the containerized continuous power system of the present disclosure, as discussed more fully below.

Known continuous power systems tend to be housed in permanent brick and mortar installations. Such installations may take many months or even years to build, and they tend to be not easily upgradeable. For those reasons, they tend to be built beyond the capacity initially needed, to allow for growth in the site's power needs. To do otherwise would tend to result in an expensive brick and mortar installation that would only briefly have the capacity to satisfy the site's needs.

Embodiments of the containerized system of the present disclosure may include an integrated power system and datacenter, but one of skill in the art will understand that the subject matter need not be limited to that type of embodiment. Other infrastructure such as compressed air, chilled water, vacuum, environmental protection, etc., may be packaged and integrated the same way. The various embodiments of this disclosure provide faster deployment time and the capability to pretest the integrated system before it is delivered to the customer site. Further, standardized or semi-customized assemblies may be offered which may help drive down cost and provide the opportunity to optimize performance.

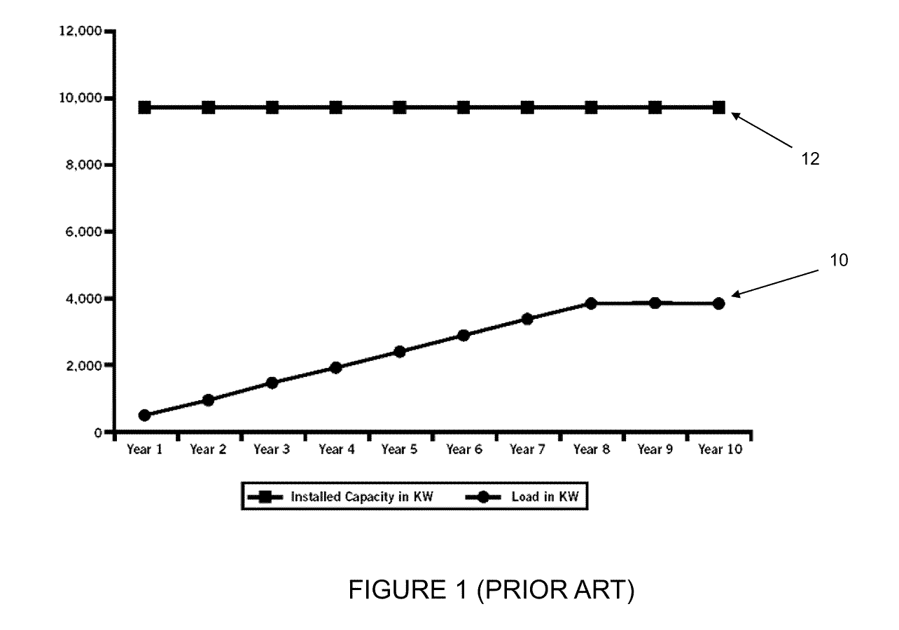

FIG. 1 is a graph showing the load requirements of an exemplary site and the installed continuous power capacity of an associated brick and mortar installation as a function of time. Load 10 is shown as growing steadily over time before reaching a plateau. The installed capacity 12 remains constant, at a level far exceeding the initial demands of the site. Because the brick and mortar installation is not easily expansible, a setup like this is the only way to allow its continued use over a period of years while load requirements grow.

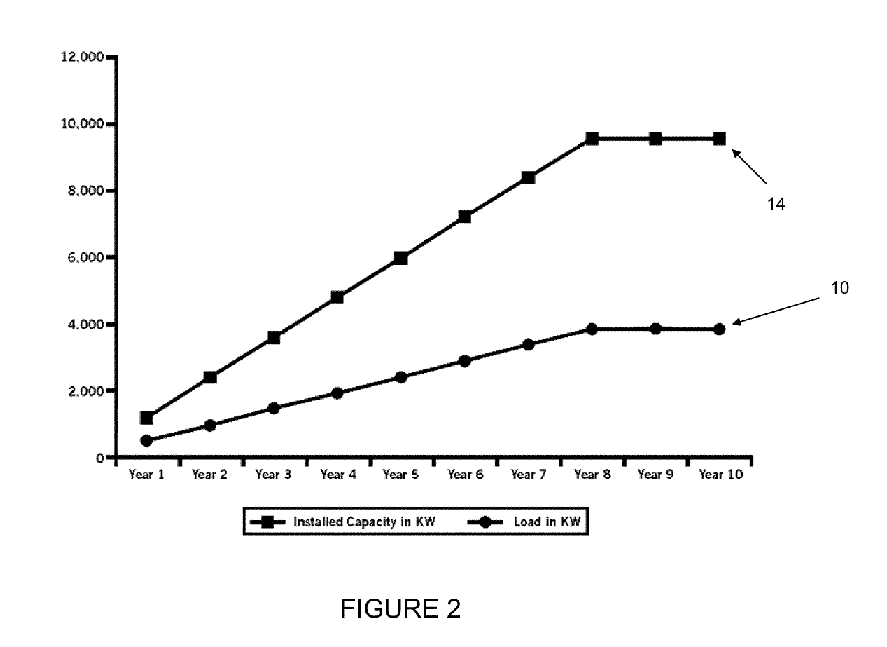

FIG. 2 shows the same load requirements 10 of FIG. 1, but with installed capacity based on the containerized system of the present disclosure. As shown, installed capacity is able to grow over time with the system of the present disclosure, keeping pace with demand and eliminating the problem of initial capacity far outstripping initial needs. This modular approach of adding capacity only when it becomes needed may free up capital in the interim, allowing it to be put to more profitable uses.

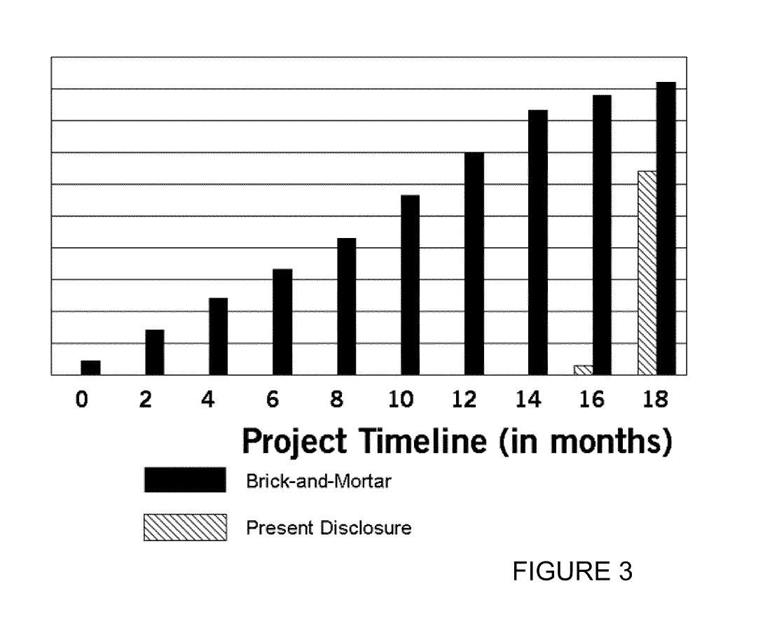

FIG. 3 shows a graph illustrating the accumulation of costs over time with traditional systems and the system of the present disclosure. Because of the quick deployment of the containerized system of the present disclosure, costs may be deferred until just before the capacity is needed. Brick and mortar systems may require heavy initial investments, tying up capital months or even years before the systems come online. As mentioned above in connection with FIG. 2, this approach may allow the more profitable investment of that capital in the interim.

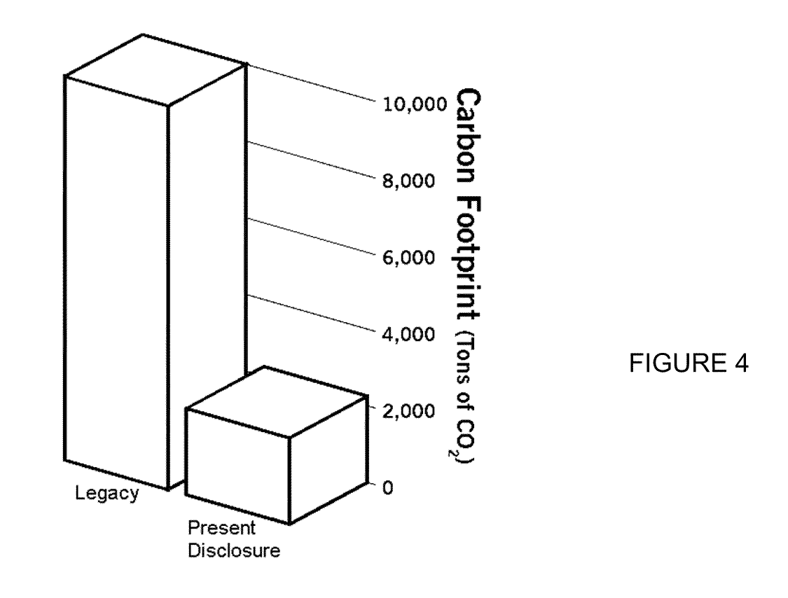

FIG. 4 is a graph showing another aspect of the present disclosure that may lead to cost savings. The incorporation of highly efficient flywheel-based UPS technology into the systems of the present disclosure, together with other energy saving aspects, reduce the amount of energy wasted by the continuous power system. Less wasted energy saves money and also reduces the carbon footprint of the system. As shown in FIG. 4, the highly efficient system of the present disclosure may reduce carbon footprint by up to 75%, compared to legacy brick and mortar continuous power systems.

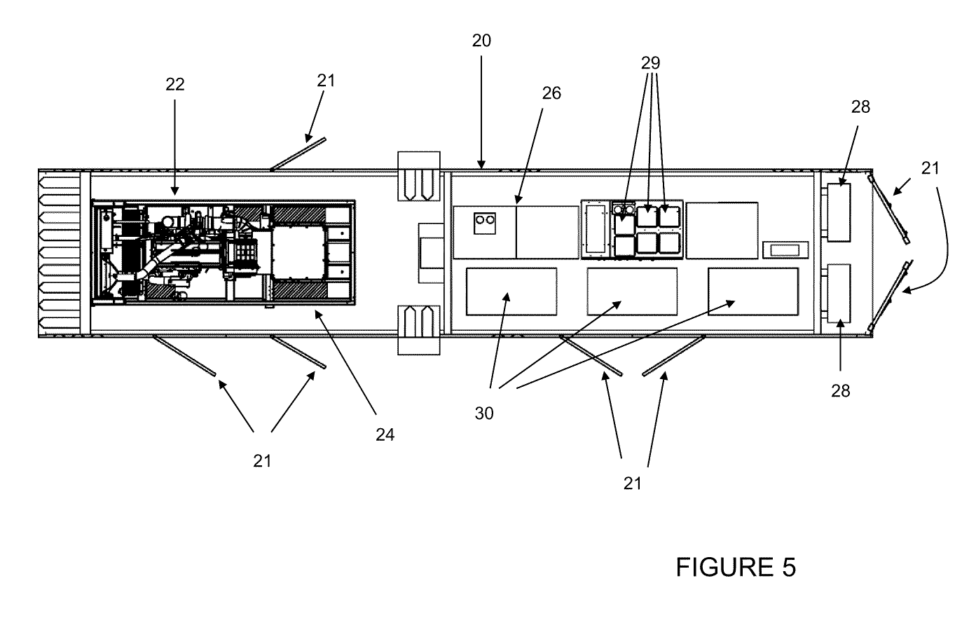

FIG. 5 shows a top view of an embodiment of an integrated single-container continuous power system in accordance with the present disclosure. The entire system is housed in container 20, which in this embodiment is a standard 40 foot high cube ISO container. Those of ordinary skill in the art will understand that other sizes and types of containers may be used without departing from the spirit of the present disclosure. Container 20 includes a plurality of doors 21 for access. Genset 22 comprises a diesel engine and an induction machine for generating up to 500 KW of power. A fuel tank (not shown) is also included in container 20.

Container 20 also contains flywheel-based UPS 24 for providing short term power (generally under about one minute, in some embodiments under about 30 seconds, and in some embodiments under about a 15 seconds) Genset 22 may take a small interval of time to come online after the failure of grid power is detected; UPS 24 is used to ride out this interval. UPS 24 may also be used to provide cranking power to start genset 22. Traditionally, a battery bank fills the role of supplying DC power to start a continuous power genset. UPS 24 may be configured to provide AC to the critical load, but its output may also be passed through a high-power rectifier to supply DC starting power to genset 22. Using the output of UPS 24 to start genset 22 may eliminate the traditional reliance on batteries, increasing the availability of the system.

Automatic transfer switch 26 controls the switchovers based on the availability of grid power, UPS power, and genset power.

In the embodiment shown in FIG. 5, container 20 also includes cooling equipment. Condensers 28 may be placed adjacent to a door to allow airflow to the outside environment. Fans 29 and ceiling split system 30 supply the chilled air to the heat-generating components (e.g., genset 22, UPS 24, automatic transfer switch 26, and other electronic components (not shown)).

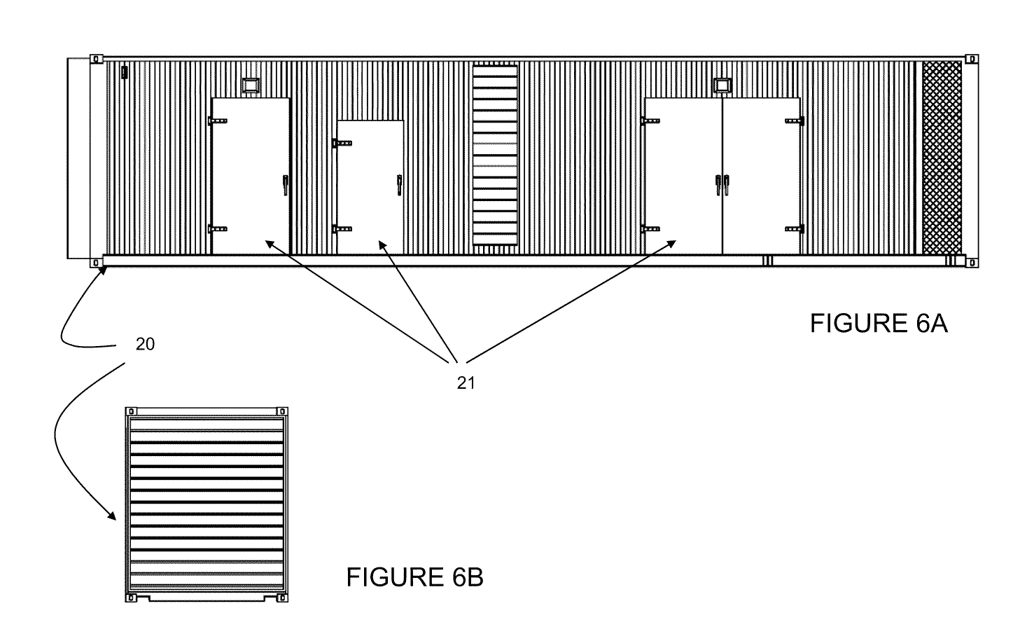

FIGS. 6A and 6B show, respectively, a side view and a top view of container 20 from FIG. 5. Doors 21 provide access to the various components inside container 20 (e.g., genset 22, UPS 24, and the cooling equipment) and may be positioned as needed.

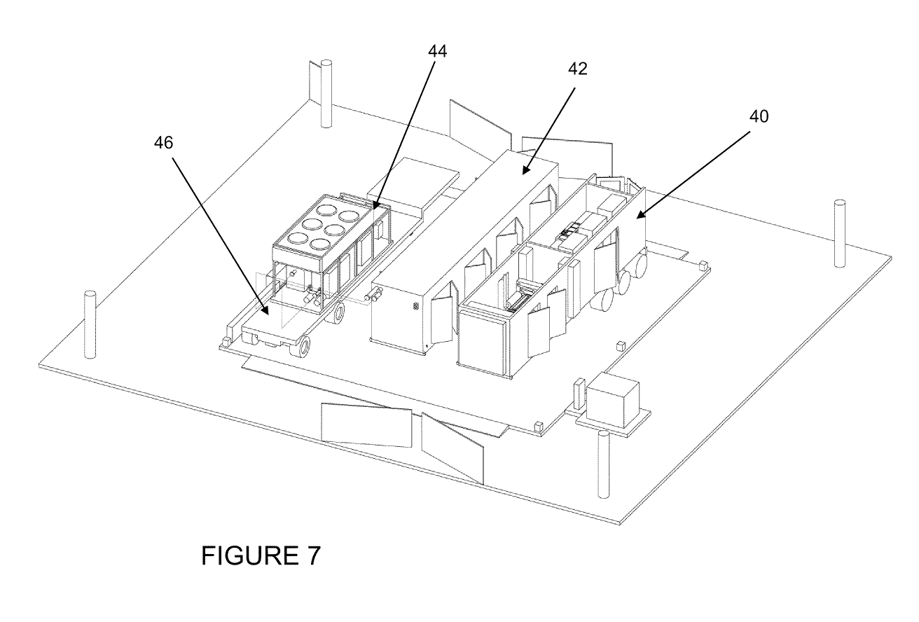

FIG. 7 shows a multi-container embodiment of the system of the present disclosure. This embodiment includes three separate enclosures: continuous power container 40, data center container 42, and chiller 44. Chiller 44, though not containerized, is shown mounted on trailer 46 for easy deployment. As demonstrated, the load supplied by the system of the present disclosure need not be limited to brick and mortar data centers or other permanent installations; without departing from the spirit of the present disclosure, the system may be advantageously deployed in concert with a containerized data center or otherwise, as one of ordinary skill in the art will recognize.

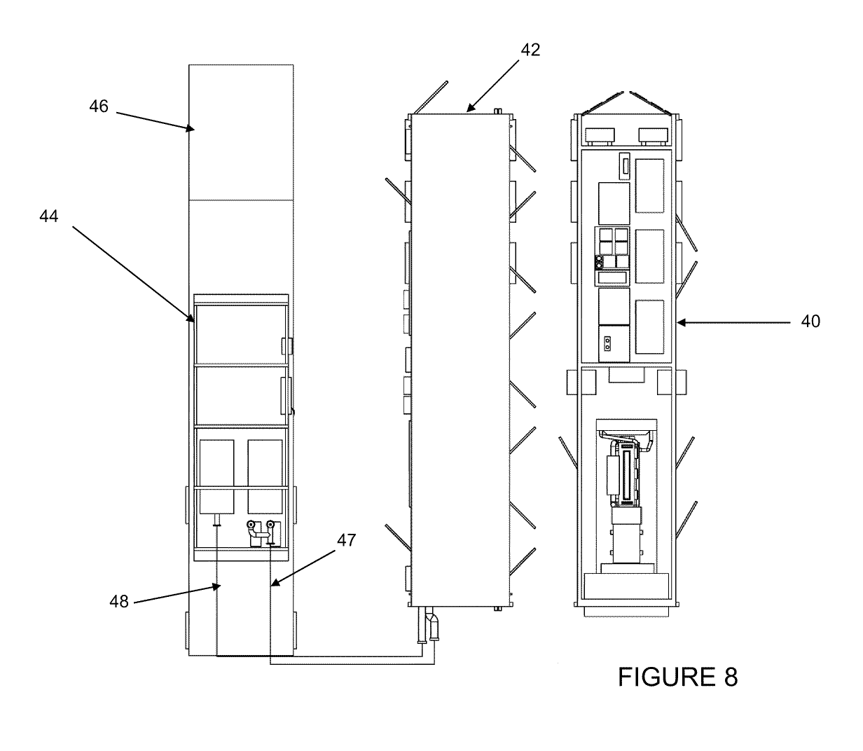

FIG. 8 shows a top view of the multi-container embodiment shown in FIG. 7. As shown, continuous power container 40 is configured in a manner generally similar to container 20.

Chiller 44 supplies data center container 42 with cooling water through cooling water supply line 47; the warmed cooling water is returned through cooling water return line 48.

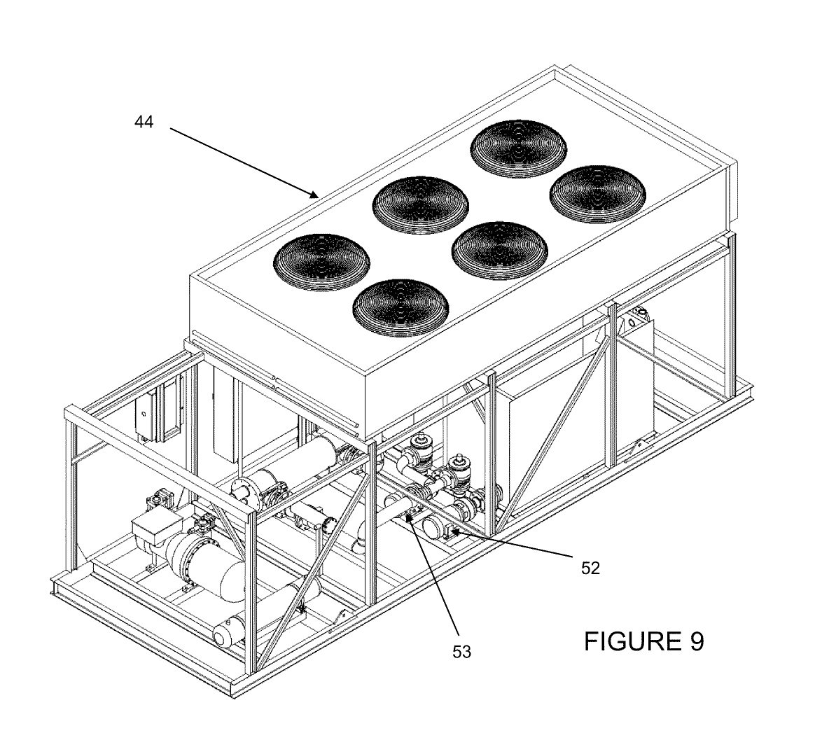

An isometric view of chiller 44 from FIG. 8 is shown in FIG. 9. Evaporator pump 52 and standby evaporator pump 53 are shown.

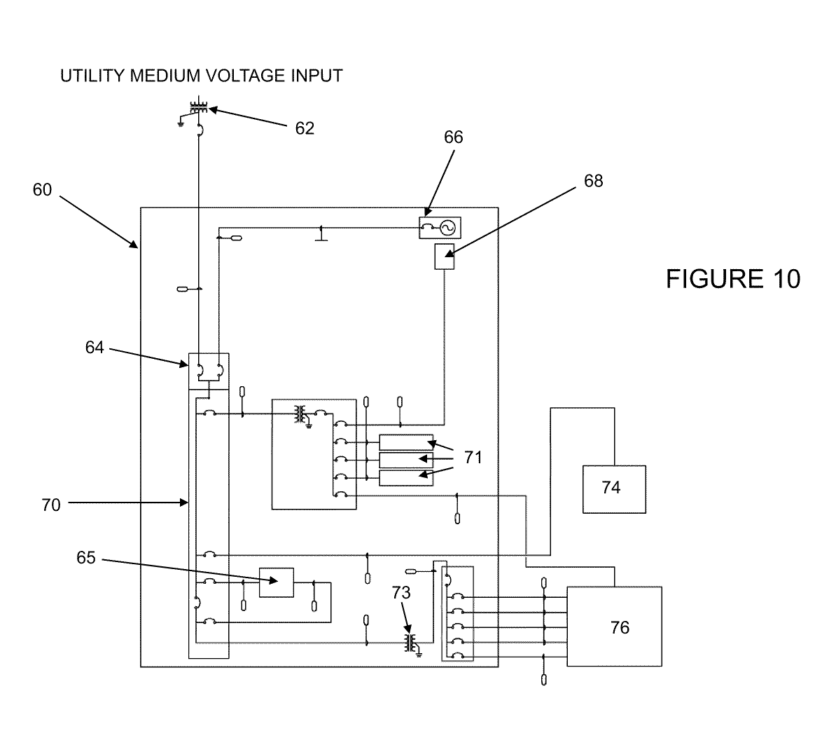

FIG. 10 shows a high-level schematic of the connections used between the different components in one embodiment of the system of the present disclosure. Box 60 designates the perimeter of the continuous power container in the embodiment shown.

Utility medium voltage input is supplied through transformer 62. Box 70 designates the distribution switchboard, including transfer switch 64. UPS 65 supplies short-term backup power in the event of a utility power failure. UPS 65 may comprise a flywheel-based UPS, or in other embodiments a battery bank could be used. The output of UPS 65 may be used to start generator 66; this may be accomplished through the connection shown at reference numeral 68. The output of UPS 65 may need to be stepped down in voltage and rectified to DC before being suitable to start generator 66. Generator 66 supplies long-term backup power, which is phase-matched to the existing utility power waveform, in the event of a protracted utility power failure. In some embodiments, generator 66 may comprise a diesel genset.

The rest of the components shown in FIG. 10 and any external device are powered by these three power sources: utility power, UPS 65, and generator 66. Distribution switchboard 70 controls which power source the loads draw power from at any given time. Containerized data center 76, in particular, is supplied via transformer 73.

AC 71 supplies cooling to the components within trailer 60. Chiller 74 supplies cooling water to containerized data center 76 (analogous to chiller 44 and data center 42 from FIG. 8).

In some embodiments, the present disclosure may also include a novel control system which displays a graphical user interface. This control system may be a software control system embodied on a tangible computer-readable medium. This interface may allow a person ignorant of the details of continuous power systems to monitor and control the containerized system of the present disclosure. For example, through a single customer connection point interface, a customer may have access to system performance metrics, security, system health, and system control functionality.

The tightly integrated design of the present disclosure may reduce costs and inefficiencies associated with current systems. For example, enabling engine and generator control via in-house ATS may reduce walk-in time and increase system reliability and availability. In some embodiments, pneumatic actuation of mechanical control devices may be enabled to further reduce inefficiencies.

The chiller shown in FIG. 9 may in some embodiments be eliminated and replaced with chilled water heat exchangers using, e.g., on-site chilled water.

The control component may provide access to such features via a high-level smart graphical user interface (GUI), utilizing a touch screen in some embodiments. The smart GUI may include visual depictions of power flow, system state, periodic subsystem testing, etc. The control component may also provide warnings and alerts via email, allowing quick dissemination of information relating to the health of the various subsystems and preventative maintenance required for various parts (e.g., filters, breakers, bearings, etc.)

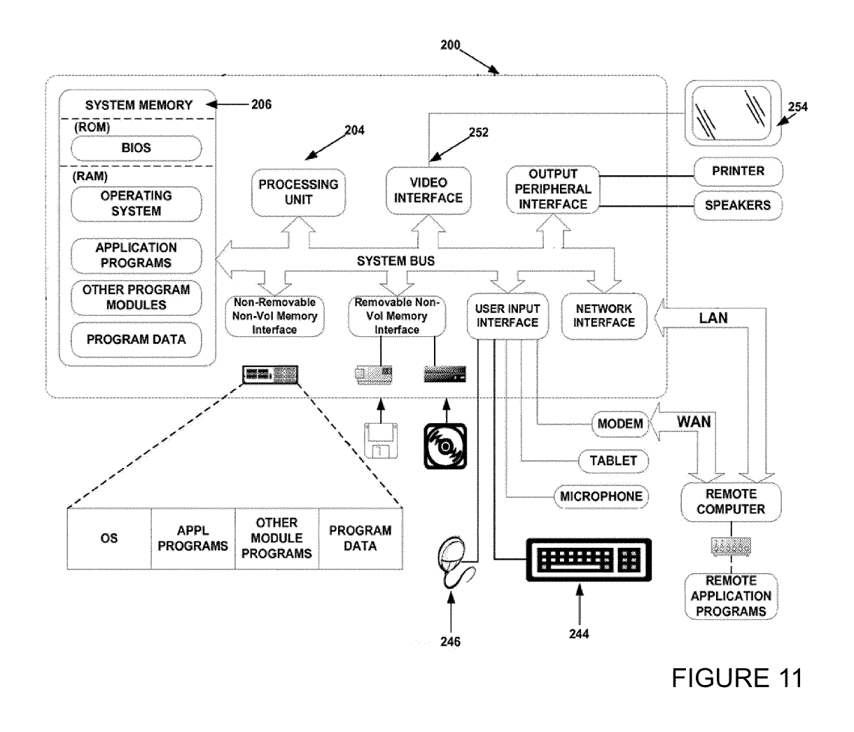

FIG. 11 shows an exemplary computer system for implementing the disclosed subject matter, which includes a general purpose computing device in the form of a computing system 200, commercially available from Intel, IBM, AMD, and others. Components of the computing system may include, but are not limited to, a processing unit 204, a system memory 206, and a system bus 236 that couples various system components. Computing system 200 typically includes a variety of computer readable media, including both volatile and nonvolatile media, and removable and non-removable media. Computer memory may include, but is not limited to, RAM, ROM, EPROM, EEPROM, flash memory, or other memory technology, CD-ROM, DVD, or other optical disk storage, magnetic disks, or any other medium which can be used to store the desired information and which can be accessed by the computing system. A user may enter commands and information into the computing system through input devices such as keyboard 244, mouse 246, or other interfaces. Monitor 254 or other type of display device may also be connected to the system bus via interface 252. Monitor 254 may also be integrated with a touch-screen panel or the like. The computing system may operate in a networked environment using logical connections to one or more remote computers. The remote computing system may be a personal computer, a server, a router, a network PC, a peer device or other common network node, and typically includes many or all of the elements described above relative to the computing system.

A computing device such as the one shown in FIG. 11 may be used to implement various parts of the software of the present disclosure.

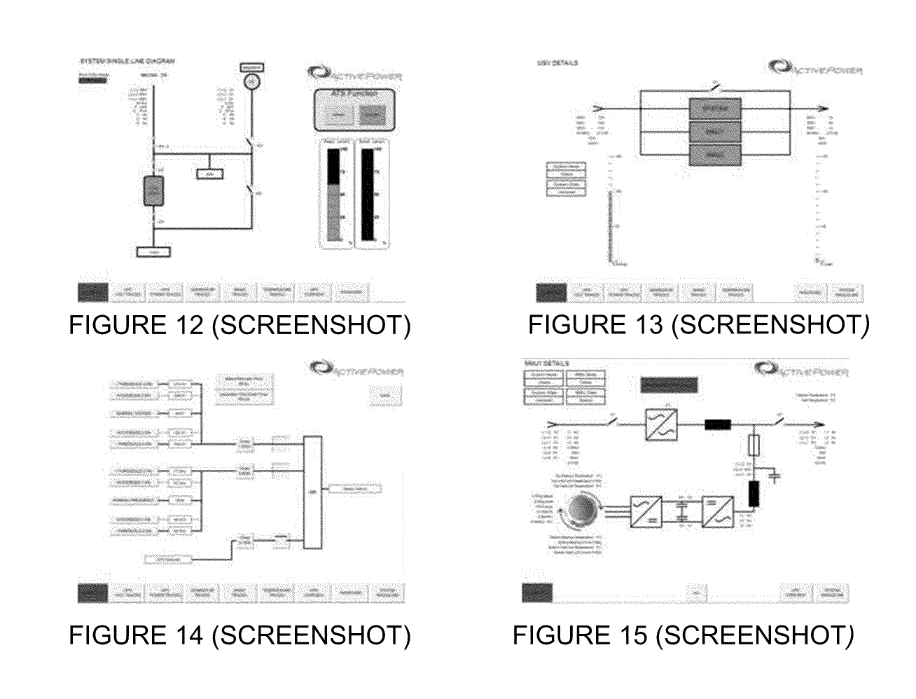

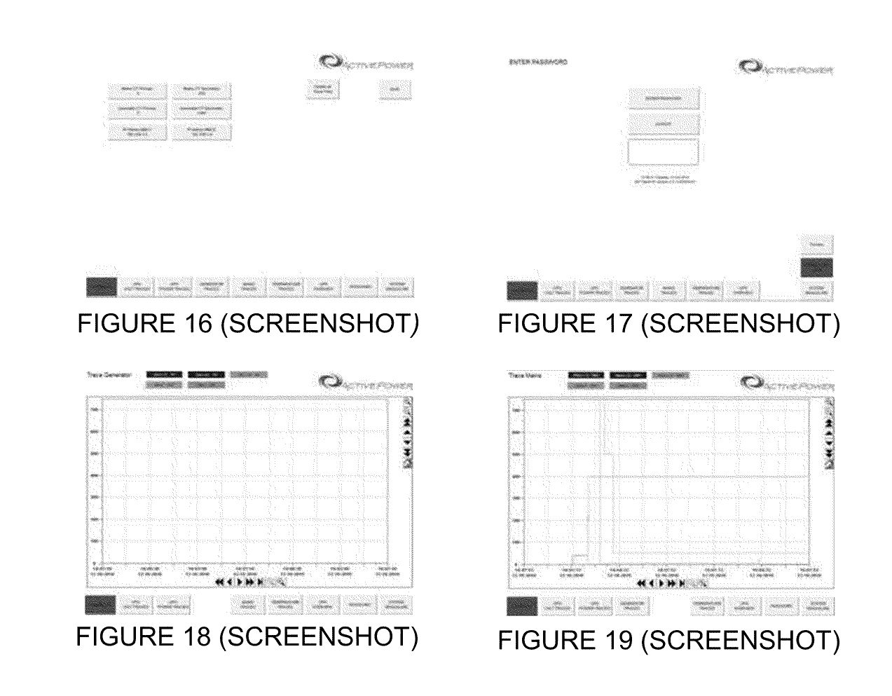

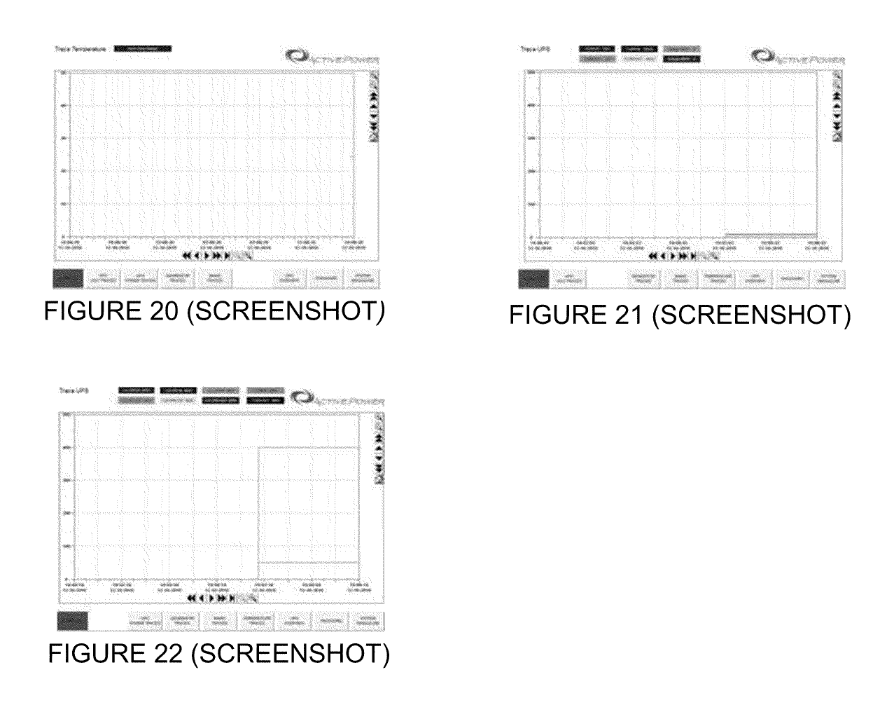

A centralized monitoring and control system is depicted in the screen shots given in FIGS. 12-22. This centralized system interfaces with the various components of the system (such as, for example, the generator, the flywheel UPS, bearings, switchgear, etc.) using their disparate protocols, aggregates the data, and presents a unified monitoring and control interface to the customer. In addition to interfacing with the components of the continuous power system, the centralized monitoring and control system may also interface with various site-specific systems (e.g. fire suppression, security, environmental controls, HVAC, compressed air systems, etc.). The centralized monitoring and control system may communicate with components using whatever protocols the components require, for example Modbus, Profibus, OPC, or any other protocols.

In addition to performing diagnostic tests on the various components, the computerized interface may further indicate maintenance intervals, which may be either preset or calculated based on measured data from the components, accumulation of runtime, or predictive algorithms. Various “learning” technologies, such as neural networks, fuzzy logic, genetic algorithms, etc., may be advantageously employed to optimize system performance and for diagnostic and maintenance purposes. This may lead to optimized financial performance as well as facilitating redundancy or “hot” hardware installations/upgrades/replacements.

The level of monitoring and control provided by this type of system can optimize the startup and synchronization of the generator to the UPS (as discussed in more detail below), shortening the amount of time required to switch to generator power and in some cases eliminating the need for batteries to start the generator. It can also optimize control of switchgear to minimize the impact of transient events and limit stress on all components. In installations using multiple parallel containerized continuous power systems, it may also improve coordination between containers, reducing transition time between power sources.

The monitoring and control system may also help prevent accidental or negligent outages. For example, it is sometimes useful during normal utility power operation to take the UPS out of circuit for testing or maintenance; this is known as putting the UPS into maintenance bypass mode. However, in manual systems, it is possible to accidentally cut power to the critical load by flipping breakers in the wrong order when entering or exiting maintenance bypass mode. The presently disclosed monitoring and control system alleviates this problem by automatically managing the transition and ensuring that all breakers are in the correct state before entering or exiting bypass mode.

In some embodiments, the monitoring aspect of the monitoring and control system is made accessible remotely, for example by modem over a telephone line. The control aspect may also be made available remotely, but this is in some cases deemed to be too much of a security concern, and thus control is restricted to on-site personnel only in those cases. The presently disclosed system allows a person to login via modem and view status information via, for example, a web page interface. This system may, however, be completely isolated from both the control aspect and from the customer's internal network. Security concerns dictate this partitioning.

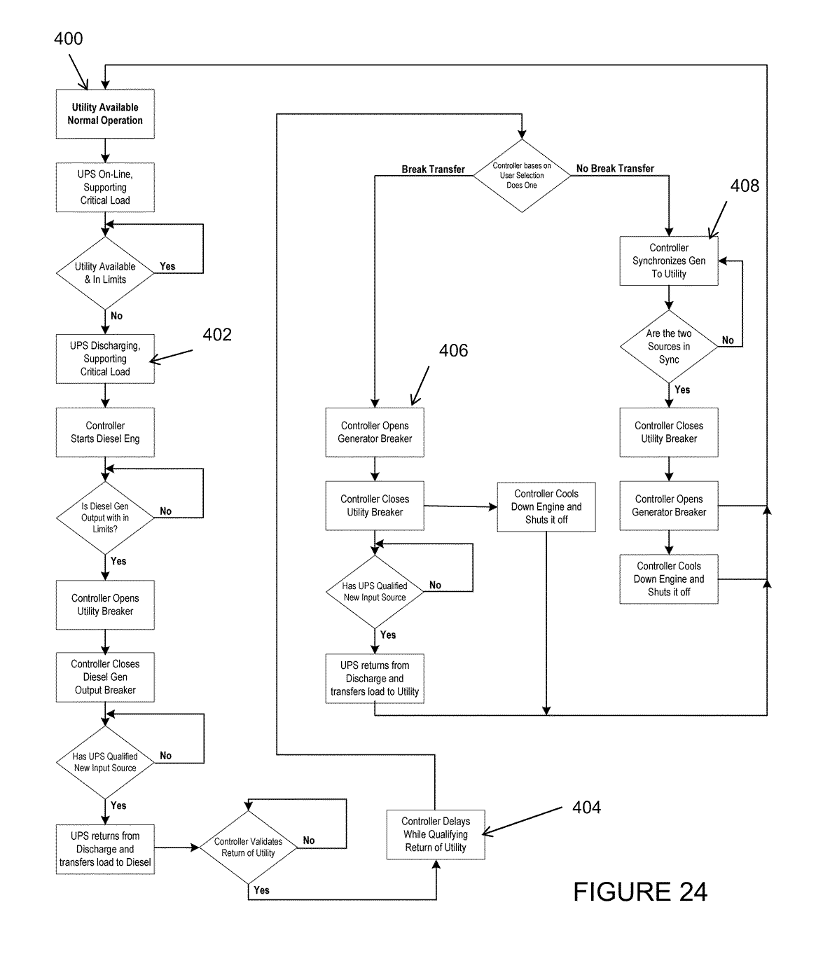

FIG. 24 shows a flowchart of one embodiment of the control logic that may be used in the present disclosure. The flowchart begins at step 400, with normal operation when utility power is available. The system is connected to utility power via the mains side of the automatic transfer switch. The generator is turned off, and the UPS delivers clean power to the output from the system. A separate output may deliver power to less-critical loads from the grid, via the automatic transfer switch. These less-critical loads are also called short-break loads, as they are allowed to experience a short break in power. One example of a short-break load is a chill water system, which may contain sufficient chilled water to ride out short interruptions in power. The system continually checks that the utility power is available and within preset limits.

When this condition fails at step 402, the UPS begins discharging and supports the load. At this time, breakers to the short-break equipment may be opened to preserve power. In order to avoid starting the generator unnecessarily, this state may persist for a programmable amount of time or until the UPS reaches a programmable level of stored energy.

After that programmable criterion has been reached, a start command is sent to the generator. The generator draws power from either batteries or the UPS, and begins cranking. The system then monitors the generator until its output stabilizes within predetermined limits. At this point, the switchgear opens the utility breaker and closes the generator breaker, and the UPS begins altering the phase angle of its output to synchronize with the generator's output. When the two are in phase, the load may be transitioned to generator power. To prevent any discontinuities in power output, the critical load may be transitioned continuously over a brief period instead of instantaneously.

Once all the critical loads are transitioned to generator power, the breakers to the short-break loads may be closed. The generator is then powering all loads, and this situation may persist for as long as is necessary. The system monitors the utility connection for a restoration of utility power.

At step 404, utility power has been returned, and the automatic transfer switch waits for a programmable amount of time to ensure that utility power is stable.

The process for transitioning back onto utility power varies based on the requirements of the jurisdiction and the utility company. This is a choice selected by the user, based on the circumstances of the installation. A “Break Transfer” is used when it is not desirable to have utility power connected in parallel with generator power, and a “No Break Transfer” is used when it is acceptable to have them connected in parallel.

In a Break Transfer, the automatic transfer switch first opens the generator breaker at step 406 and then closes the utility breaker. The UPS synchronizes phase with the utility power, and then it begins running from utility power. The generator may be cooled down and shut off in parallel with this process.

In a No Break Transfer, the generator need not be isolated from utility power. Once the automatic transfer switch has qualified the return of utility power, it synchronizes the generator to utility power at step 408 and then closes the utility breaker. The automatic transfer switch then opens the generator breaker, the generator is cooled and shut down, and the system returns to normal operation at step 400.

In either scenario, a built-in delay (typically on the order of 5 minutes) may also prevent the transition back to utility power until the generator has reached its nominal operations temperature. This aids in achieving economical use of the generator.

This whole process may be monitored from the centralized monitoring and control system. Status conditions, measured values, and events may be seen from every device in the entire continuous power system, such as: flywheel UPS, automatic transfer switch, generator, distribution switchboard for the critical and the short-break loads, battery bank, redundant engine starting device for starting from UPS power, temperature measurement devices, and environmental control devices.

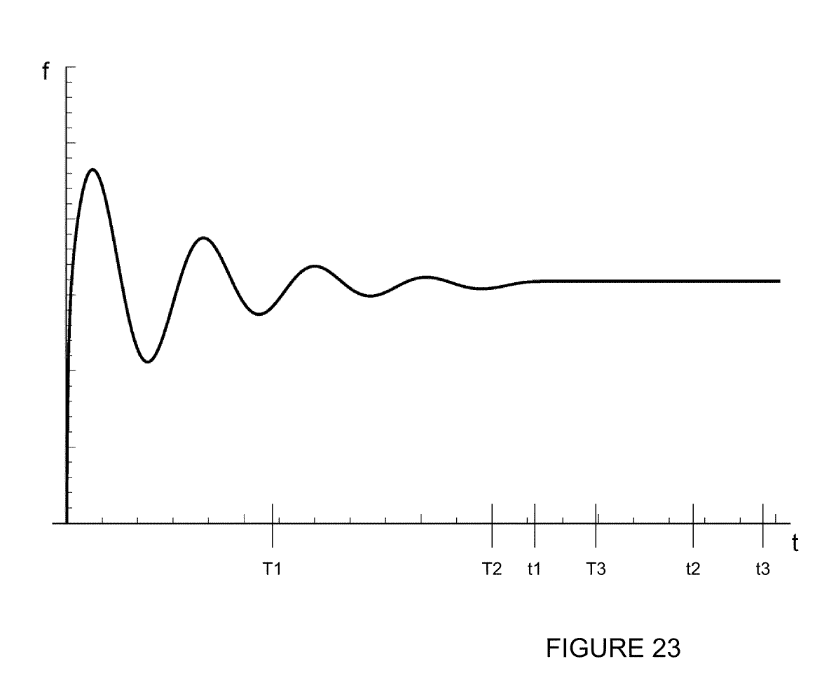

FIG. 23 shows a graph of generator RPM f versus time t for illustrating two different embodiments of the automatic transfer switch, which is used to transition critical and less-critical loads from failed utility power to generator power.

(The frequency fluctuations and time demarcations are not necessarily shown to scale, but are depicted for ease of exposition.) At time t=0, the generator receives the signal to start. In some embodiments, the generator will draw starting power from a battery bank, and in the case of a battery failure, may draw power from the UPS itself. In other embodiments, the batteries may be entirely eliminated, and the generator may simply rely on the UPS for starting power.

The graph in FIG. 23 begins after utility power has failed, and the breakers to all less-critical (or short-break) loads have been opened.

From t=0 to t=t1, the generator's RPM fluctuates as the governor hunts for its nominal frequency (in some embodiments, this is 1800 RPM for 60 Hz countries and 1500 RPM for 50 Hz countries). This may take several seconds, during which the UPS discharges and supplies the critical load. Once the generator reaches its nominal frequency, the automatic transfer switch opens the utility breaker and closes the generator breaker. The UPS then begins to match phase with the generator at time t=t1; phase matching is finished at time t=t2. The UPS may then begin transitioning the critical load to generator power. At time t=t3, all critical load has been transitioned to generator power, and the breakers to the less-critical loads may be closed. This process may take on the order of 12 seconds from the time the generator begins cranking to the time the critical load has been fully transitioned. Once the critical load is transitioned, the short-break breakers are closed, and the generator supplies power to all critical and less-critical loads.

Another embodiment of the automatic transfer switch may be useful for more quickly transitioning to generator power. In this embodiment, as soon as the generator starts (essentially at t=0 or shortly thereafter), the automatic transfer switch closes the generator breaker instead of waiting for the generator to reach its nominal frequency. In order to make this safe, all motors and other devices that cannot withstand frequency fluctuations should be connected to the short-break breakers, and will thus already be disconnected and not exposed to frequency fluctuations.

Instead of waiting for the generator to reach its nominal frequency, the UPS starts phase matching earlier in this embodiment. The exact threshold for beginning matching is adjustable, but +/−30% of nominal voltage and +/−3 Hz frequency has been found to be an acceptable window, shown as time t=T1 in FIG. 23.

At time t=T2, phase matching is complete, and at time t=T3, the critical load has been transferred to generator power and the short-break breakers may be closed. This embodiment significantly cuts down on the time required to transition from UPS power to generator power.

This quick transition may allow a smaller UPS to be used in a given system, since it could stand to be discharged more quickly and still transition to generator power before it was fully discharged. This may enable both economic and space savings, allowing more room in a container for other components.

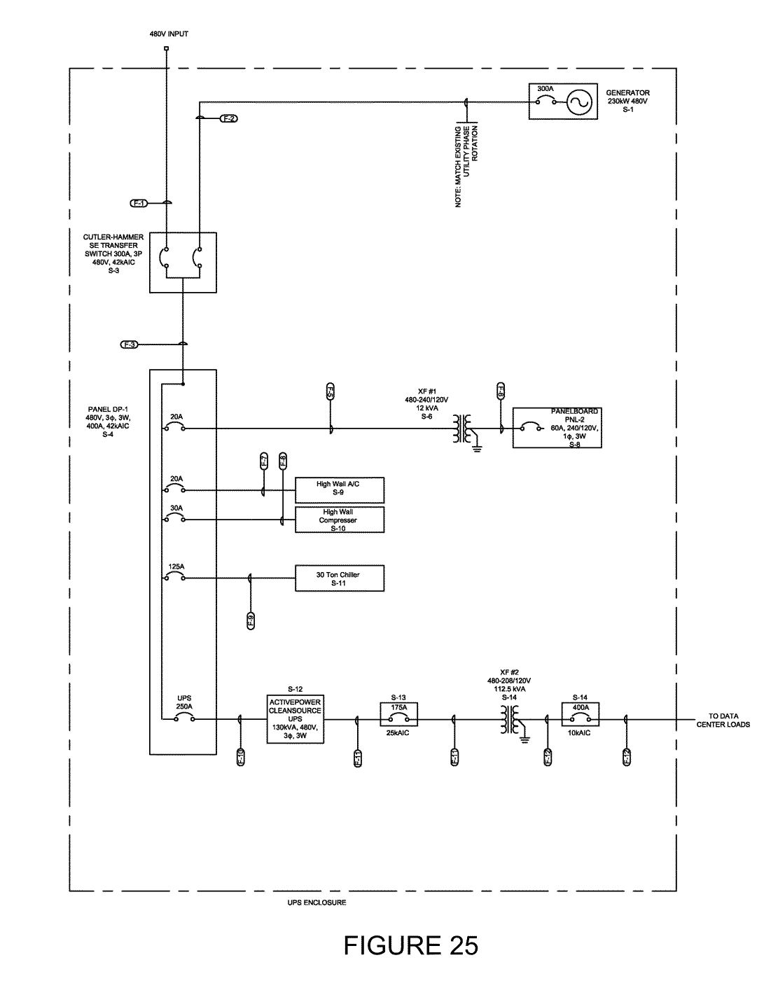

FIGS. 25-28 show high-level schematic diagrams of several possible embodiments of the present disclosure.

In FIG. 25, the following two tables summarize the connections and devices shown:

| I.D. | DESCRIPTION | AMPS | VOLTS/PHASE |
|---|---|---|---|
| F-1 | Utility Input | 300 | 480 V, 3 Phase |
| F-2 | Emergency Power Input | 300 | 480 V, 3 Phase |
| F-3 | From Transfer Switch to Switchboard | 300 | 480 V, 3 Phase |
| F-4 | Not Used | | |
| F-5 | To Step Down Transformer #1 | 40 | 480 V, 1 Phase, |
| | | | 2 W |
| F-6 | To Manual Bypass Switch | 60 | 240/120 V |
| F-7 | To 2.5 Ton Mini-Split Wall Unit | 20 | 480 V, 3 Phase |
| F-8 | To 2.5 Ton Mini-Split Wall Mount | 30 | 480 V, 3 Phase |
| | Compressor | | |
| F-9 | To 30 Ton Chiller | 125 | 480 V, 3 Phase |
| F-10 | To 130 KVA UPS Unit | 250 | 480 V, 3 Phase |
| F-11 | From UPS Unit to Disconnect Switch | 175 | 480 V, 3 Phase, |
| | | | 3 W |
| F-12 | From Transformer to Data Center Load | 400 | 480 V, 3 Phase, |
| | | | 3 W |

| I.D. | DESCRIPTION | KVA | AMPS | MFG | VOLTS/PHASE |
|---|---|---|---|---|---|
| S-1 | 230 KW Generator | 287 | 300 | Cummins | 480 V, 3 Phase |
| | with 300 A Output | | | | |
| | Breaker | | | | |
| S-2 | 300 A Normal Input | | 300 | GE | 480 V, 3 Phase |
| | Breaker | | | | |
| S-3 | 300 A Automatic | | 300 | Cut-Ham | 480 V, 3 Phase |
| | Transfer Switch | | | | |
| S-4 | 400 A Distribution | | 400 | GE | 480 V, 3 Phase, |
| | Panel | | | | 3 W |
| S-5 | Not Used | | | | |
| S-6 | 12 KVA Transformer | 12 | 25/50 | GE | 480-240/120 V |
| S-7 | Not Used | | | | |
| S-8 | 60 A Auxiliary Panel | | 60 | GE | 240, 1 Phase, |
| | Board PNL-2 | | | | 3 W |
| S-9 | 2.5 Ton Mini-Split | | 16 | York | 480 V, 3 Phase |
| | Wall Mounted | | | | |
| | HVAC Unit | | | | |
| S-10 | 2.5 Ton Wall | | 23 | York | 480 V, 3 Phase |
| | Mounted Mini-Split | | | | |
| | Condensing Unit | | | | |
| S-11 | 30 Ton Chiller | | 85 | Advantage | 480 V, 3 Phase, |
| | | | | | 3W Input |
| S-12 | 130 KVA UPS Unit | 130 | 250 | Active | 480 V, 3 Phase, |
| | | | | Power | 3W |
| S-13 | 175 Amp Output | | 175 | SQD | 480 V, 3 Phase, |
| | Breaker | | | | 3 W |
| S-14 | 112.5KVA | 112.5 | 135/313 | SQD | 480 V- |
| | Transformer | | | | 208/120 V |
| S-15 | 400 A Output | | 400 | SQD | 208 V, 3 Phase, |
| | Breaker | | | | 3 W |

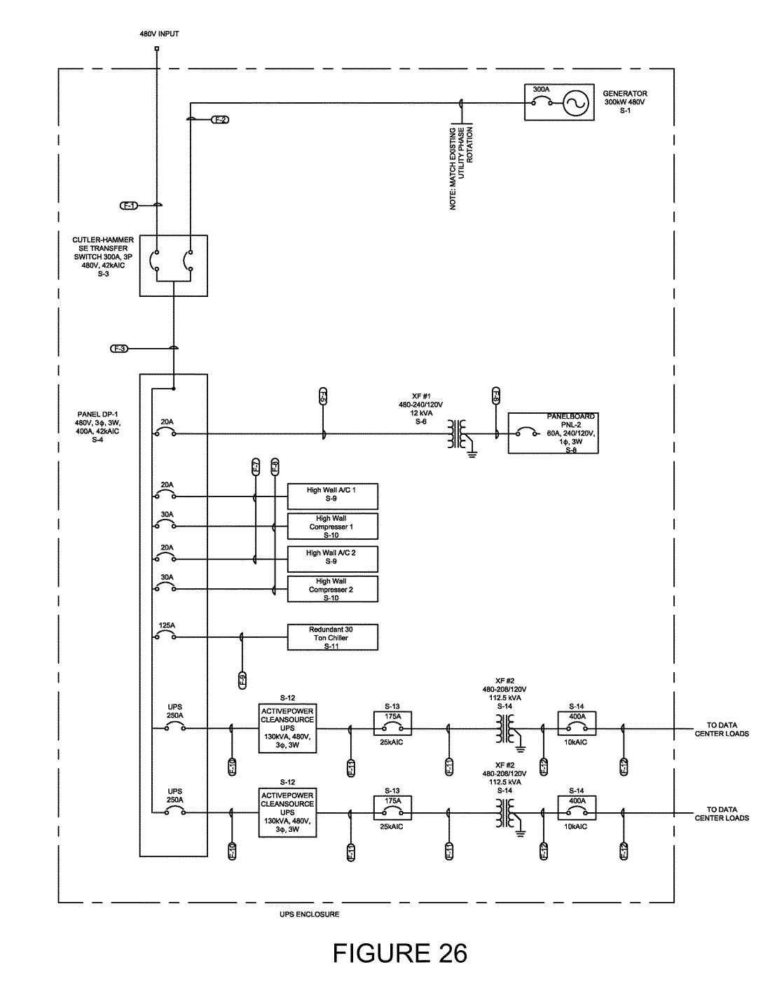

The following two tables summarize the devices and connections shown in FIG. 26.

| I.D. | DESCRIPTION | AMPS | VOLTS/PHASE |
|---|---|---|---|
| F-1 | Utility Input | 300 | 480 V, 3 Phase |
| F-2 | Emergency Power Input | 300 | 480 V, 3 Phase |
| F-3 | From Transfer Switch to Switchboard | 300 | 480 V, 3 Phase |
| F-4 | Not Used | | |
| F-5 | To Step Down Transformer #1 | 40 | 480 V, 1 Phase, |
| | | | 2 W |
| F-6 | To Manual Bypass Switch | 60 | 240/120 V |
| F-7 | To 2.5 Ton Mini-Split Wall Unit | 20 | 480 V, 3 Phase |
| F-8 | To 2.5 Ton Mini-Split Wall | 30 | 480 V, 3 Phase |
| | Mount Compressor | | |
| F-9 | To 30 Ton Chiller | 125 | 480 V, 3 Phase |
| F-10 | To 130 KVA UPS Unit | 250 | 480 V, 3 Phase |
| F-11 | From UPS Unit to Output Breaker | 175 | 480 V, 3 Phase, |
| | | | 3 W |
| F-12 | From Transformer to Data Center | 400 | 480 V, 3 Phase, |
| | Load | | 3 W |

| I.D. | DESCRIPTION | KVA | AMPS | MFG | VOLTS/PHASE |
|---|---|---|---|---|---|
| S-1 | 300 KW Generator | 375 | 300 | Cummins | 480 V, 3 Phase |
| | with 350 A Output | | | | |
| | Breaker | | | | |
| S-2 | 300 A Normal Input | | 300 | GE | 480 V, 3 Phase |
| | Breaker | | | | |
| S-3 | 300 A Automatic | | 300 | Cut-Ham | 480 V, 3 Phase |
| | Transfer Switch | | | | |
| S-4 | 400 A Distribution | | 400 | GE | 480 V, 3 Phase, |
| | Panel | | | | 3W |
| S-5 | Not Used | | | | |
| S-6 | 12 KVA Transformer | 12 | 25/50 | GE | 480- |
| S-7 | Not Used | | | | 240/120 V |
| S-8 | 60 A Auxiliary Panel | | 60 | GE | 240, 1 Phase, |
| | Board PNL-2 | | | | 3 W |
| S-9 | 2.5 Ton Mini-Split | | 16 | York | 480 V, 3 Phase |
| | Wall Mounted | | | | |
| | HVAC Unit | | | | |
| S-10 | 2.5 Ton Wall | | 23 | York | 480 V, 3 Phase |
| | Mounted Mini-Split | | | | |
| | Condensing Unit | | | | |
| S-11 | 30 Ton Redundant | | 85 | Advantage | 480 V, 3 Phase, |
| | Chiller | | | | 3W Input |
| S-12 | 130 KVA UPS Unit | 130 | | Active | 480 V, 3 Phase, |
| | | | | Power | 3W |
| S-13 | 175 Amp Output | | 175 | SQD | 480 V, 3 Phase, |
| | Breaker | | | | 3W |
| S-14 | 112.5 KVA | 112.5 | 135/313 | SQD | 480 V- |
| | Transformer | | | | 208/120 V |
| S-15 | 400A Output | | 400 | SQD | 208 V, 3 Phase, |
| | Breaker | | | | 3 W |

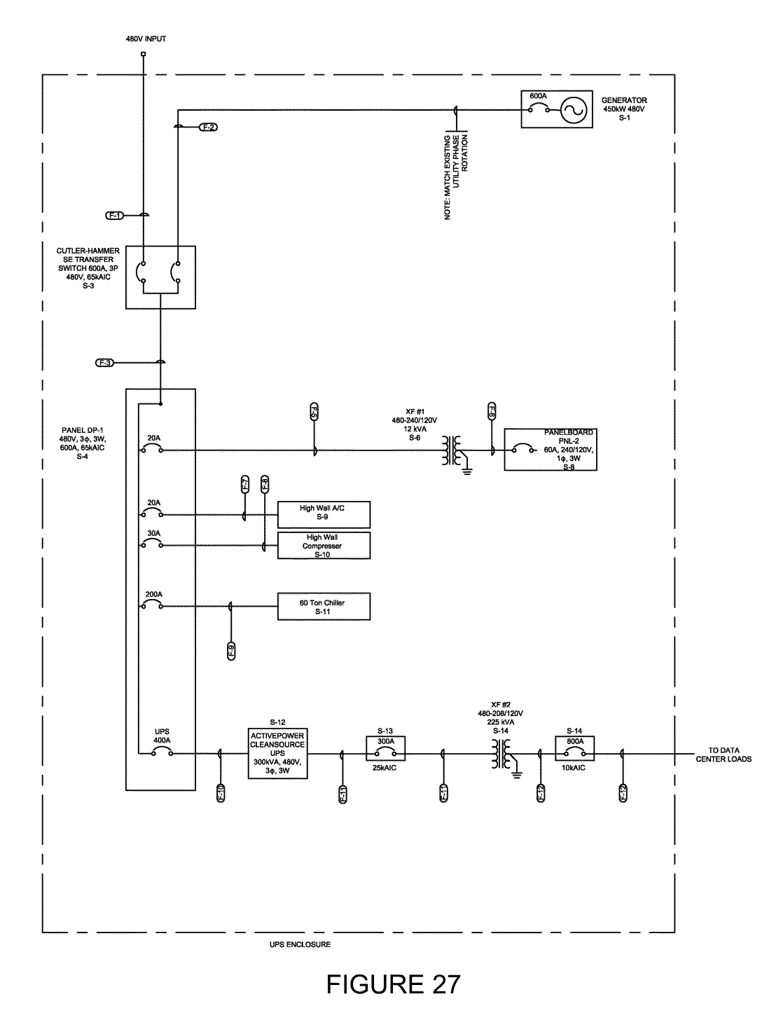

The following two tables summarize the devices and connections shown in FIG. 27.

| I.D. | DESCRIPTION | AMPS | VOLTS/PHASE |
|---|---|---|---|
| F-1 | Utility Input | 600 | 480 V, 3 Phase |
| F-2 | Emergency Power Input | 600 | 480 V, 3 Phase |
| F-3 | From Transfer Switch to Switchboard | 600 | 480 V, 3 Phase |
| F-4 | Not Used | | |
| F-5 | To Step Down Transformer #1 | 40 | 480 V, 1 Phase, |
| | | | 2 W |
| F-6 | To Manual Bypass Switch | 60 | 240/120 V |
| F-7 | To 2.5 Ton Mini-Split Wall Unit | 20 | 480 V, 3 Phase |
| F-8 | To 2.5 Ton Mini-Split Wall | 30 | 480 V, 3 Phase |
| | Mount Compressor | | |
| F-9 | To 60 Ton Chiller | 200 | 480 V, 3 Phase |
| F-10 | To 300 KVA UPS Unit | 400 | 480 V, 3 Phase |
| F-11 | From UPS Unit to Output Breaker | 300 | 480 V, 3 Phase, |
| | | | 3 W |
| F-12 | From Transformer to Data Center | 800 | 480 V, 3 Phase, |
| | Load | | 3 W |

| I.D. | DESCRIPTION | KVA | AMPS | MFG | VOLTS/PHASE |
|---|---|---|---|---|---|
| S-1 | 450 KW Generator | 562 | 600 | Cummins | 480 V, 3 Phase |
| | with 600 A Output | | | | |
| | Breaker | | | | |
| S-2 | 600 A Normal Input | | 600 | GE | 480 V, 3 Phase |
| | Breaker | | | | |
| S-3 | 600 A Automatic | | 600 | Cut-Ham | 480 V, 3 Phase |
| | Transfer Switch | | | | |
| S-4 | 600 A Distribution | | 600 | GE | 480 V, 3 Phase, |
| | Panel | | | | 3 W |
| S-5 | Not Used | | | | |
| S-6 | 12 KVA Transformer | 12 | 25/50 | GE | 480-240/120 V |
| S-7 | Not Used | | | | |
| S-8 | 60 A Auxiliary Panel | | 60 | GE | 240, 1 Phase, |
| | Board PNL-2 | | | | 3 W |
| S-9 | 2.5 Ton Mini-Split | | 16 | York | 480 V, 3 Phase |
| | Wall Mounted | | | | |
| | HVAC Unit | | | | |
| S-10 | 2.5 Ton Wall | | 23 | York | 480 V, 3 Phase |
| | Mounted Mini-Split | | | | |
| | Condensing Unit | | | | |
| S-11 | 60 Ton Chiller | | 157 | Advantage | 480 V, 3 Phase, |
| | | | | | 3W Input |
| S-12 | 300 KVA UPS Unit | 300 | 364 | Active | 480 V, 3 Phase, |
| | | | | Power | 3W |
| S-13 | 300 Amp Output | | 200 | SQD | 480 V, 3 Phase, |
| | Breaker | | | | 3 W |
| S-14 | 225 KVA | 225 | 271/625 | SQD | 480 V- |
| | Transformer | | | | 208/120 V |
| S-15 | 800 A Output | | 800 | SQD | 208 V, 3 Phase, |
| | Breaker | | | | 3 W |

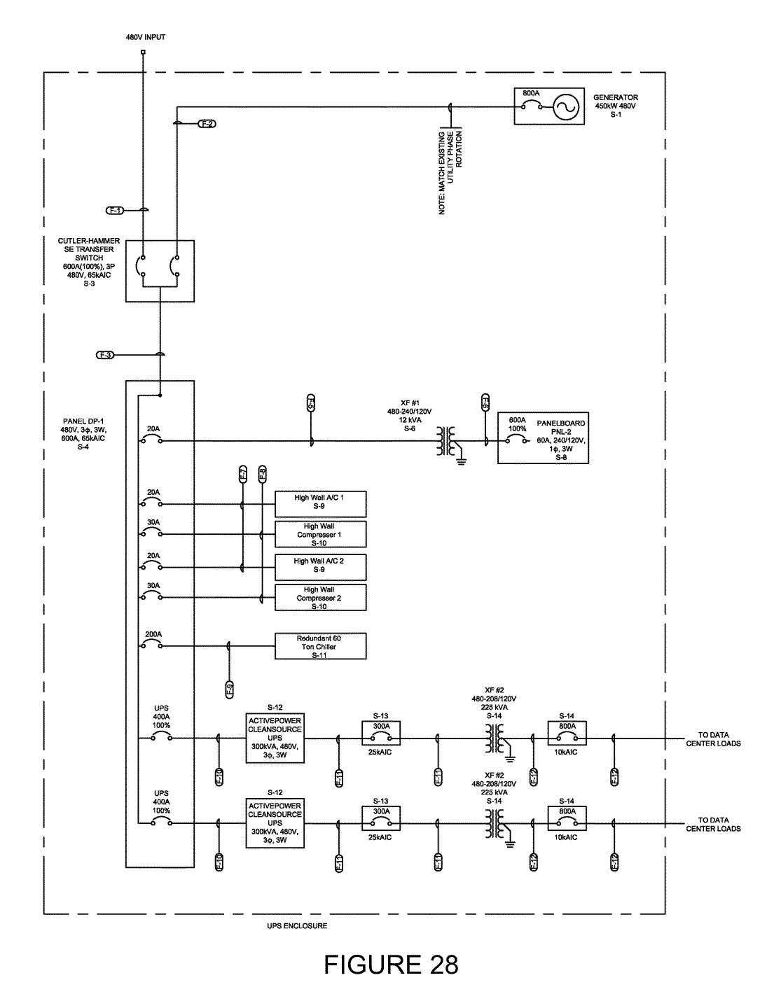

The following two tables summarize the devices and connections shown in FIG. 28.

| I.D. | DESCRIPTION | AMPS | VOLTS/PHASE |
|---|---|---|---|
| F-1 | Utility Input | 600 | 480 V, 3 Phase |
| F-2 | Emergency Power Input | 600 | 480 V, 3 Phase |
| F-3 | From Transfer Switch to Switchboard | 600 | 480 V, 3 Phase |
| F-4 | Not Used | | |
| F-5 | To Step Down Transformer #1 | 40 | 480 V, 1 Phase, |
| | | | 2 W |
| F-6 | To Manual Bypass Switch | 60 | 240/120 V |
| F-7 | To 2.5 Ton Mini-Split Wall Unit | 20 | 480 V, 3 Phase |
| F-8 | To 2.5 Ton Mini-Split Wall | 30 | 480 V, 3 Phase |
| | Mount Compressor | | |
| F-9 | To 30 Ton Chiller | 90 | 480 V, 3 Phase |
| F-10 | To 130KVA UPS Unit | 400 | 480 V, 3 Phase |
| F-11 | From UPS Unit to Disconnect Switch | 300 | 480 V, 3 Phase, |
| | | | 3 W |
| F-12 | From Transformer to Data Center Load | 800 | 480 V, 3 Phase, |
| | | | 3 W |

| I.D. | DESCRIPTION | KVA | AMPS | MFG | VOLTS/PHASE |
|---|---|---|---|---|---|
| S-1 | 450 KW Generator | 563 | 600 | Cummins | 480 V, 3 Phase |
| | with 600 A Output | | | | |
| | Breaker | | | | |
| S-2 | 600 A Normal Input | | 600 | GE | 480 V, 3 Phase |
| | Breaker | | | | |
| S-3 | 600 A Automatic | | 600 | Cut-Ham | 480 V, 3 Phase |
| | Transfer Switch | | | | |
| S-4 | 600 A Distribution | | 600 | GE | 480 V, 3 Phase, |
| | Panel | | | | 3 W |
| S-5 | Not Used | | | | |
| S-6 | 12 KVA Transformer | 12 | 25/50 | GE | 480-240/120 V |
| S-7 | Not Used | | | | |
| S-8 | 60 A Auxiliary Panel | | 60 | GE | 240, 1 Phase, |
| | Board PNL-2 | | | | 3 W |
| S-9 | 2.5 Ton Mini-Split | | 16 | York | 480 V, 3 Phase |
| | Wall Mounted | | | | |
| | HVAC Unit | | | | |
| S-10 | 2.5 Ton Wall | | 23 | York | 480 V, 3 Phase |
| | Mounted Mini-Split | | | | |
| | Condensing Unit | | | | |
| S-11 | 60 Ton Redundant | | 157 | Advantage | 480 V, 3 Phase, |
| | Chiller | | | | 3 W Input |
| S-12 | 300 KVA UPS Unit | 300 | | Active | 480 V, 3 Phase, |
| | | | | Power | 3W |
| S-13 | 300 Amp Output | | 300 | SQD | 480 V, 3 Phase, |
| | Breaker | | | | 3 W |
| S-14 | 112.5 KVA | 225 | 271/625 | SQD | 480 V- |
| | Transformer | | | | 208/120 V |
| S-15 | 800A Output Breaker | | 800 | SQD | 208V, 3 Phase, |
| | | | | | 3 W |

These tables and the corresponding FIGURES demonstrate the modularity and extensibility of the continuous power systems of the present disclosure; however, one of ordinary skill will recognize that these are simply examples of certain configurations, and this disclosure encompasses more than just these specific examples.

The foregoing description of illustrative embodiments is provided to enable a person skilled in the art to make and use the disclosed subject matter. Various modifications to these embodiments will be readily apparent to those skilled in the art, and the generic principles defined herein may be applied to other embodiments without the use of the innovative faculty.

What is claimed is:

1. A container comprising:
a plurality of power sources, said plurality of power sources comprising:
a generator for supplying long-term continuous power, further comprising a fuel tank connected to said generator for supplying fuel to said generator; and
a short-term power supply comprising a flywheel-based UPS;
an automatic transfer switch for automatically selecting among said plurality of power sources and a source of utility power; and
a computerized interface capable of communicating with said generator, said short-term power supply, and said automatic transfer switch,
said computerized interface further capable of presenting a unified monitoring and control interface to a user,
wherein said container is capable of being delivered to an installation site in a configured arrangement and deployed relatively rapidly,
and wherein said plurality of power sources, said automatic transfer switch, and said computerized interface are capable of being pre-tested at a manufacturing site prior to said delivery.

2. The container of claim 1, further comprising a battery for starting said generator.

3. The container of claim 2, further comprising a DC/AC converter coupled between said short-term power supply and said generator, said DC/AC converter operable as a backup generator starting device.

4. The container of claim 1, further comprising a DC/AC converter coupled between said short-term power supply and said generator, said DC/AC converter operable as a sole generator starting device.

5. The container of claim 1, wherein said computerized interface is operable via an off-site communications medium.

6. The container of claim 5, wherein said off-site communications medium comprises a telephone modem.

7. The container of claim 5, wherein said computerized interface provides a web-based interface when operating via said telephone modem.

8. The container of claim 1, wherein said computerized interface is further in communication with a fire suppression system, a security system, or an environmental control system.

9. The container of claim 8, wherein said environmental control system comprises a chilled water supply, a water chiller, or an HVAC system.

10. The container of claim 1, wherein said computerized interface is further in communication with at least one of a containerized data center, a video camera, a building monitoring system, and a fuel or chemical delivery system.

11. The container of claim 1, wherein said computerized interface is operable to optimize system performance based on a learning technology.

12. The container of claim 1, wherein said automatic transfer switch further comprises:
a first breaker coupled to a critical load; and
a second breaker coupled to a less-critical load,
said second breaker capable of automatically disconnecting said less-critical load during an interruption in utility power.

13. The container of claim 12, wherein said second breaker is further capable of automatically reconnecting said less-critical load when said critical load has been transitioned to said generator.

14. The container of claim 1, wherein said automatic transfer switch is capable of transitioning from generator power to utility power according to either a Break Transfer or a No Break Transfer.

15. The container of claim 14, wherein a decision between said Break Transfer and said No Break Transfer is a user-selectable decision.

16. The container of claim 1, wherein said automatic transfer switch is operable to detect a condition wherein said generator has reached a nominal frequency and a nominal voltage, and after said condition has been attained said automatic transfer switch is operable to close a generator breaker and allow phase matching between said generator and said short-term power supply.

17. The container of claim 1, wherein said automatic transfer switch is operable to detect a condition wherein said generator has reached a window around a nominal frequency and a window around a nominal voltage, and after said condition has been attained said automatic transfer switch is operable to close a generator breaker and allow phase matching between said generator and said short-term power supply.

18. The container of claim 1, wherein said computerized interface allows said user to perform diagnostic checks on at least one monitored system.

19. The container of claim 1, wherein said computerized interface allows said user to perform testing on at least one monitored system.

20. The container of claim 1, wherein said computerized interface is capable of providing a notification to said user via text message or email.
